(19) United States
(12) Patent Application Publication
(10) Pub. No.: US 2006/0218590 A1
(43) Pub. Date: Sep. 28, 2006

(54) System and method for displaying an electronic program guide

(75) Inventor: Scott White, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/077,167

(22) Filed: Mar. 10, 2005

(51) Int. Cl. H04N 5/445; G06F 13/00; G06F 3/00

(52) U.S. Cl. 725/46

(57) ABSTRACT

In a particular embodiment, a method of displaying an electronic program guide on a display device is disclosed. The method displays the electronic program guide including visual indicators related to a perceived user interest level associated with a plurality of programs that may be displayed. The method includes determining a user preference level for each of the plurality of programs within the electronic program guide and assigning a visual indicator having a visual treatment that corresponds to the user preference level. The user preference level is indicated in accordance with a visual metaphor. The method also includes displaying the electronic program guide including the visual indicators on the display device.

### FIELD OF THE DISCLOSURE

The present disclosure relates generally to a system and method of displaying an electronic program guide.

### BACKGROUND

With the addition of many new channels on cable and digital satellite systems, television users have increased viewing options. One method to provide viewers with the ability to identify programs that they desire to watch is through electronic program guides. Such electronic program guides may display on a particular channel the programs that are being broadcast on other stations currently and during a specific time window, such as for the next two hours. While such electronic program guides may be helpful, with the increased number and type of program offerings and with a continuing goal to enhance the viewer experience by reducing viewer program selection time, it would be desirable to further assist viewers with their selection of desired programs. Accordingly, there is a need for an improved system and method for displaying an electronic program guide.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of a home entertainment system;

FIG. 2 is a flow chart to illustrate an embodiment of a method of displaying an electronic program guide; and

FIG. 3 is a diagram of an embodiment of a graphical user interface display of an electronic program guide.

### DETAILED DESCRIPTION OF THE DRAWINGS

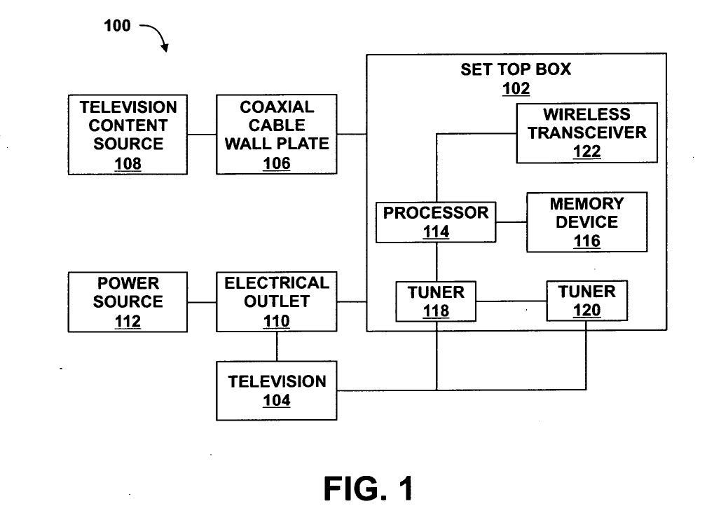

Referring to FIG. 1, an exemplary, non-limiting embodiment of a home entertainment system is shown and is generally designated 100. As illustrated in FIG. 1, the home entertainment system 100 includes a set top box 102 that is coupled to a television 104. FIG. 1 also shows that the set top box 102 is coupled to a cable wall plate 106 via a cable and the cable wall plate 106, in turn, is coupled to a television content source 108. In a particular embodiment, the set top box 102 is coupled to the cable wall plate via a coaxial cable, a category five (CAT-5) cable, or a telephone cable. Further, television content can be provided to the cable wall plate 106 via a coaxial cable, a CAT-5 cable, or a telephone cable. The television content source 108 can be a digital content provider and the digital content can be broadcast to the system 100 via a satellite connection.

FIG. 1 further depicts that the television 104 is coupled to an electrical outlet 110 that is coupled to a power source 112. In a particular embodiment, the power source 112 is a one-hundred and ten/one-hundred and twenty volt (110/120V) alternating current (AC) power source. As depicted in FIG. 1, the set top box 102 is also coupled to the electrical outlet 110 and receives power from the power source 112.

FIG. 1 depicts that the set top box 102 includes a processor 114 coupled to a memory device 116. In a particular embodiment, the memory device 116 can be a random access memory (RAM) device, a flash memory device, or any other type of electronically erasable programmable read only memory (EEPROM) device or other non-volatile memory device, such as a hard disk drive. As illustrated in FIG. 1, the set top box 102 further includes a first television tuner 118 and a second television tuner 120 that are each coupled to the processor 114. The television tuners 118, 120 can decode digital television signals received at the set top box 102 and transmit the decoded digital television signals to the television 104.

Further, the processor 114 can execute a computer program in order to display video content stored at the memory device 116. In a particular embodiment, the processor 114 can execute a computer program to display an electronic program guide interface on the television 104. FIG. 1 also shows that the set top box 102 can include a wireless transceiver 122. The wireless transceiver 122 can allow the set top box 102 to communicate with a wireless network, another set top box, or any other device having a wireless transceiver. In a particular embodiment, the wireless transceiver 122 is a radio frequency (RF) transceiver, an ultra high frequency (UHF) transceiver, or a wireless high fidelity (Wi-Fi) transceiver, such as an 802.11 transceiver.

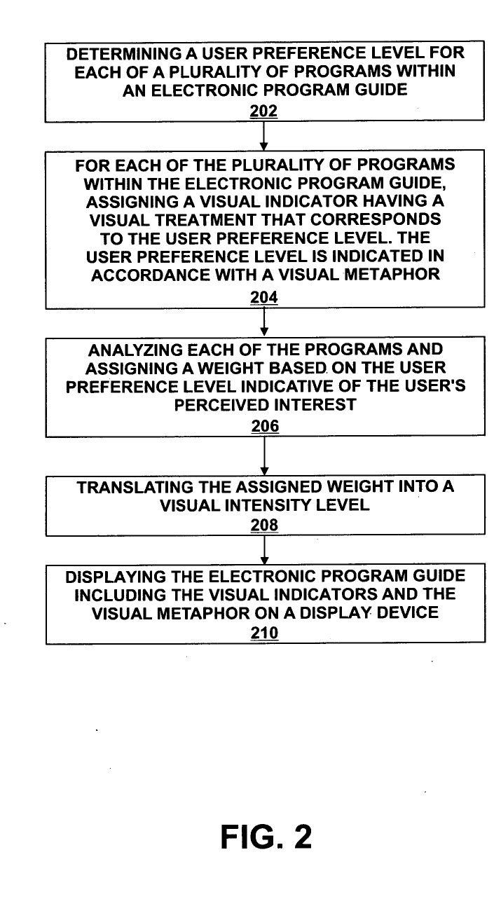

Referring to FIG. 2, a method of displaying an electronic programming guide on a display device is illustrated. In this particular embodiment, the electronic programming guide includes visual indicators related to a perceived user interest level as associated with a plurality of programs that may be displayed on the display device. The method includes determining a user preference level for each of the plurality of programs within the electronic programming guide, as shown at 202. For each of the plurality of programs within the electronic program guide, the method includes assigning a visual indicator having a visual treatment. In a particular example, the visual treatment may include a color and/or a visual intensity level. The visual treatment corresponds to the user preference level and the user preference level is indicated in accordance with a visual metaphor, as shown at 204.

An example of the visual metaphor is a traffic light metaphor that would include green, yellow and red colors. In this example, green would indicate high user interest, yellow indicates moderate user interest, and red would indicate no user interest in a particular program. Another example of a visual metaphor is a hot/cold metaphor including the colors of shades of red and blue. In another embodiment, the visual metaphor is a positive/negative metaphor including colors with variant shadings of white and black. In yet a further embodiment, the visual metaphor may be a fading metaphor having colors of bold to grey.

In a particular embodiment, the user preference level may be determined by detecting an explicit user preference based on a user input. For example, the user interest level may be determined by user input collected by the set top box through a user input device, such as a remote control unit. Alternatively, the user preference level may be determined through an implicit determination of user preferences based on historical user usage patterns. The method of displaying the electronic programming guide further includes analyzing each of the programs and assigning a weight based on the user preference level that indicates the user's perceived interest, as shown at 206. The method further includes translating the assigned weight into a visual intensity level, as shown at 208.

In a particular exemplary embodiment, the weight is translated into a particular color shade and/or intensity level. The program weight may be represented by a corresponding degree of visual treatment as indicated. In a particular embodiment, the electronic programming guide is fully colored and the visual treatment that corresponds to the program weight is presented in a kinesthetic manner. In a particular example, the weight of a first program to be displayed is related to the weight of a second program to be displayed. In one example, the first weight is assigned to a first program and a second weight is assigned to a second program that is a similar type to the first program, wherein the second weight is based at least in part on the value of the first weight. The method of displaying the electronic programming guide further includes displaying the electronic programming guide on the display device. The electronic programming guide displayed includes the visual indicators and the visual metaphor, as shown at 210. The electronic program guide may be stored prior to being displayed within a memory of a computer system, such as within the memory 116 of the set-top box 102 as shown in FIG. 1.

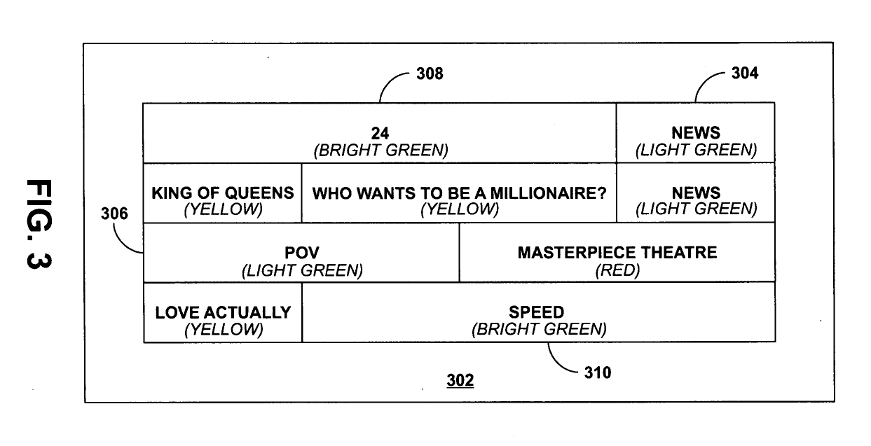

Referring to FIG. 3, an illustrated embodiment of a displayed electronic programming guide including color-coding and visual metaphor indicators is shown. The electronic program guide 302 includes a plurality of programs selectable for display. The plurality of illustrated programs includes the program “24” 308, news 304, POV 306, and speed 310. The color for programs with a high degree of user interest may be displayed with a first degree of visual intensity, such as the news program 304. In addition, programs that have hotter colors that represent higher user interest levels may be displayed in a higher intensity color such as bright green, such as the programs “24” 308 and speed 310. Thus, the electronic program guide 302 includes dynamic color-coding based on actively or passively expressed user interest in programs with certain meta data (series, title, genre, actors, etc.).

For example, the Electronic Program Guide 302 (EPG) indicates through dynamic color-coding that the user, through either passive use (spent lots of time watching certain series or types of programming) or active designation (selected certain types of programming, or specific series), has established that they like news and REALLY like action. Based on this information, the EPG has been dynamically color-coded to display degrees of potential interest. In this example, ‘hot’ colors represent shows in which the user is likely to be interested, with ‘hotter’ colors representing even higher interest. Conversely, shows and genres in which the user has expressed little interest are displayed in ‘cool’ colors, or are grayed out. This color-coding method could be combined with user profile management, such that each user in the household could access a different ‘Interest-Colored’ EPG presentation. Also, a mechanism for actively tuning the ‘Interest Coloration’ could be presented on the EPG by interacting directly with a show. The interactive data could have a ‘chain reaction’ effect on other similar programs. For example, the user could decide that they're not really that interested in news, and downgrade the coloration of the local news shows. This would by extension downgrade the coloration of ‘POV’. This relationship need not be 1-to-1. In other words, specifically downgrading ‘local news’ may result in downgrading ‘POV’, but to a lesser degree.

In a particular embodiment, the set top box 102 monitors metadata that is received for use with the electronic program guide. In a particular embodiment, the electronic program guide is a color-coded guide that can be presented at a television and can include information, such as program title, program type, episode title, episode synopsis, episode rating, closed captioning information, broadcast date, broadcast time, and channel information. In a digital system, the data comprising the electronic program guide and the metadata associated with the electronic program guide is transmitted as part of the Advanced Television Systems Committee Motion Pictures Experts Group-Two (ATSC MPEG-2) stream.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of displaying an electronic program guide on a display device, the electronic program guide including visual indicators related to a perceived user interest level associated with a plurality of programs that may be displayed, the method comprising:
determining a user preference level for each of the plurality of programs within the electronic program guide;
for each of the plurality of programs within the electronic program guide, assigning a visual indicator having a visual treatment that corresponds to the user preference level, wherein the user preference level is indicated in accordance with a visual metaphor; and
displaying the electronic program guide including the visual indicators on the display device.

2. The method of claim 1, wherein the visual metaphor is a traffic light metaphor including green, yellow, and red colors.

3. The method of claim 1, wherein determining the user preference level includes detecting explicit user preferences based on user input, and wherein the visual treatment includes a color and a visual intensity level.

4. The method of claim 1, wherein determining the user preference level includes an implicit determination of user preferences based on historical user usage patterns.

5. The method of claim 3, further comprising analyzing each of the programs and assigning a weight based on the user preference level indicative of the user's perceived interest.

6. The method of claim 5, wherein the weight is translated into a particular visual intensity level.

7. The method of claim 5, wherein the weight is translated into a particular color shade.

8. The method of claim 1, wherein the visual metaphor is a hot/cold metaphor including the colors of shades of red and blue.

9. The method of claim 1, wherein the visual metaphor is a positive/negative metaphor including colors with variant shadings of white and black.

10. The method of claim 1, wherein the visual metaphor is a fading metaphor having colors of bold to gray.

11. The method of claim 5, wherein the program weight is represented by a corresponding degree of visual treatment.

12. The method of claim 11, wherein the electronic program guide is fully colored and wherein the visual treatment is presented in a kinesthetic manner.

13. The method of claim 12, wherein the weight of a first program affects the weight of a second program of a similar type as the first program.

14. The method of claim 1, wherein a first weight is assigned to a first program and wherein a weight of a second program that is similar to the first program is assigned a second weight based at least in part on the first weight.

15. A set top box system coupled to a display device, the set top box system comprising:
a processor;
a computer readable memory accessible to the processor, the computer readable memory including data defining an electronic program guide that may be displayed on the display device, the electronic program guide including visual indicators related to a perceived user interest level associated with a plurality of programs that may be displayed, wherein for each of the plurality of programs identified by the electronic program guide, a visual indicator is assigned that has a visual treatment that corresponds to a user preference level, wherein the user preference level is indicated in accordance with a visual metaphor.

16. The system of claim 15, wherein the visual metaphor is a traffic light metaphor including green, yellow, and red colors.

17. The system of claim 15, wherein the user preference level is determined based upon explicit user preference input.

18. The system of claim 15, wherein a weight is assigned to each of the programs based on the user preference level indicative of the user's perceived interest and wherein the weight is translated into a particular visual intensity level.

19. The system of claim 15, wherein the electronic program guide is fully colored and wherein the visual treatment is presented in a kinesthetic manner.

20. An electronic program guide that may be displayed as a user interface on a display device, the electronic program guide comprising:
a plurality of visual indicators related to a perceived user interest level associated with a plurality of programs that may be displayed, wherein for each of the plurality of programs identified by the electronic program guide, a visual indicator is assigned that has a visual treatment that corresponds to a user preference level, wherein the user preference level is indicated in accordance with a visual metaphor.

21. The electronic program guide of claim 20, wherein the visual metaphor is a traffic light metaphor including green, yellow, and red colors.

22. The electronic program guide of claim 21, wherein the user preference level is determined based upon explicit user preference input.
